(19) United States
(12) Patent Application Publication
(10) Pub. No.: US 2020/0029635 A1
(43) Pub. Date: Jan. 30, 2020

(54) MOTION-RESTRICTING WEARABLE SAFETY DEVICE

(71) Applicant: Microsoft Technology Licensing, LLC, Redmond, WA (US)

(72) Inventors: Kenneth Liam KIEMELE, Redmond, WA (US); Christian Michael SADAK, Seattle, WA (US); Adolfo HERNANDEZ SANTISTEBAN, Bothell, WA (US); Scott Christopher SPEIRS, Redmond, WA (US); James David HOLBERY, Bellevue, WA (US); Kelly Marie BOGAN, Redmond, WA (US); Sang Ho YOON, Redmond, WA (US)

(73) Assignee: Microsoft Technology Licensing, LLC, Redmond, WA (US)

(21) Appl. No.: 16/046,708

(22) Filed: Jul. 26, 2018

(51) Int. Cl. A41D 19/015; G05B 13/02; A41D 1/00; A41D 13/08; A41D 19/00

(52) U.S. Cl. CPC A41D 19/015; G05B 13/0265; A41D 2600/20; A41D 13/087; A41D 19/0027; A41D 1/002

(57) ABSTRACT

Examples are disclosed that relate to a wearable device configured to physically prevent a user from interacting with an identified hazard. One disclosed example provides a wearable device including a motion-restricting system configured to restrict movement of a skeletal joint when activated, a logic subsystem, and memory storing instructions executable by the logic subsystem to receive sensor data from one or more sensors, based at least on the sensor data received, determine whether the wearable device is likely to be in an unsafe state, and when the wearable device is determined likely to be in the unsafe state, send a control signal to the motion-restricting system to activate the motion-restricting system.

### BACKGROUND

Workplace safety is a concern for businesses and employees worldwide, as many different jobs expose employees to potentially hazardous situations and/or involve using equipment with the potential to cause injury. As a result, businesses generally invest significant resources in training and tools related to workplace safety.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to a wearable device configured to help a user avoid interacting with an identified hazard. One disclosed example provides a wearable device including a motion-restricting system configured to restrict movement of a skeletal joint when activated, a logic subsystem, and memory storing instructions executable by the logic subsystem to receive sensor data from one or more sensors, based at least on the sensor data received, determine whether the wearable device is likely to be in an unsafe state, and when the wearable device is determined likely to be in the unsafe state, send a control signal to the motion-restricting system to activate the motion-restricting system.

### BRIEF DESCRIPTION OF THE DRAWINGS

FIG. 1 shows an example use scenario in which a motion-restricting system of a wearable device is activated based upon sensor data received from one or more sensors local to the wearable device.

FIG. 2 shows an example use scenario in which a motion-restricting system of a wearable device is activated based upon sensor data received from one or more sensors external to the wearable device.

FIG. 3 schematically shows aspects of an example motion-restricting system comprising a clutch mechanism.

FIG. 4 schematically shows aspects of an example motion-restricting system comprising a fluid having an adjustable viscosity.

FIG. 5 schematically shows aspects of an example motion-restricting system comprising a mechanical motion-restricting mechanism.

FIG. 6 shows a block diagram illustrating an example system for implementing one or more motion restricting wearable devices.

FIG. 7 shows a flowchart illustrating an example method for controlling a motion-restricting system via logic local to a wearable device.

FIG. 8 shows a flowchart illustrating an example method for controlling a motion-restricting system via logic external to a wearable device.

FIG. 9 shows a block diagram illustrating an example computing system.

### DETAILED DESCRIPTION

Many occupational situations may pose risks of injury. For example, common objects such as mechanical and electrical devices, electrical lines, heating devices, and the like may pose risks of burn, electrical shock, and/or mechanical trauma. Injuries arising in such situations may be fatal or nonfatal, and may be the result of preventable accidents. Household objects may pose similar risks.

In view of these risks, businesses and organizations invest significant time and money in accident prevention and safety training. Such investments may include purchasing new equipment with up-to-date safety features, training employees on the proper operation of machinery and tools, identifying workplace hazards and training employees on how to avoid injury from such hazards, (e.g., hot surfaces, sharp objects, heavy machinery, rotating objects, etc.), and providing training on local and federal safety regulations. While safety training may inform persons of potential dangers and approaches to minimize exposure to such dangers, accidents still may occur, for example, when a person is distracted or when a dangerous situation cannot be easily sensed by a user.

Various professional and consumer products may be used to help a user to sense hazardous situations, such as voltage and current meters, temperature sensors, acoustic sensors, gas sensors, etc. However, many such instruments are handheld and do not allow a person to obtain measurements in a hands-free manner, which may limit use while the person is actively working with one or both hands. Further, such instruments do not physically help to impede a person from accidently or intentionally interacting with a hazardous situation.

Accordingly, examples are disclosed that relate to wearable devices for physically impeding user interaction with the impending hazard identified via a motion-restricting system. The motion restricting system may be actuated based upon hazards sensed via data from sensors local to the wearable device and/or sensors remote from the wearable device. The wearable device may take the form of a glove, an arm sleeve, a knee sleeve, and/or any other suitable article configured to be worn by a person while working or performing a task. The wearable device may include intelligent processing capabilities to make real-time decisions regarding a potentially hazardous situation, which may be identified via heuristics and/or machine learning techniques. Such decisions also may be received from an external device in some examples, such as from a machine being used by a person wearing the wearable device. Upon identification of a hazardous condition, the motion-restricting system may be actuated to restrict movement of a skeletal joint(s) on which the wearable device is worn, thereby helping to prevent the user from moving further toward the hazardous situation.

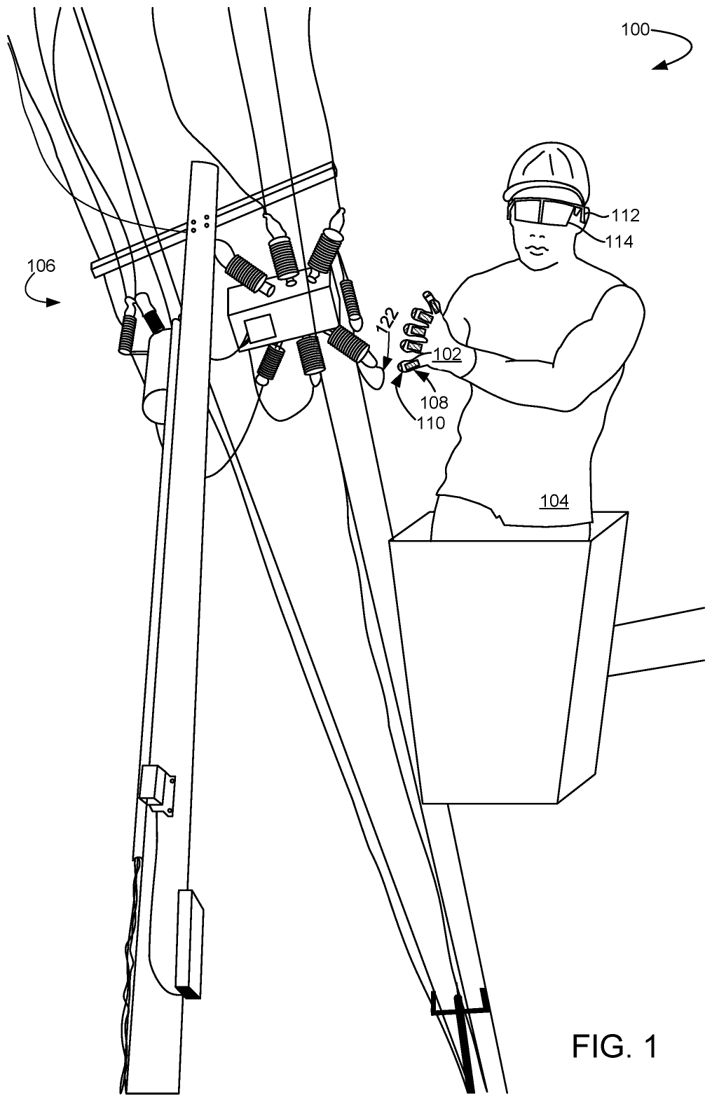

FIG. 1 depicts an example use scenario 100 for a wearable device 102 in the form of an electronic glove. In this example, an electrician 104 is performing maintenance on a high voltage power line 106 while wearing the wearable device 102. The wearable device 102 includes a motion-restricting system with motion restricting components 108 positioned along knuckles of the hand and haptic actuators 110 at positions corresponding to fingertips. The electrician also wears a head-mounted display device 112 comprising a see-through display device 114 configured to display virtual imagery admixed with real world imagery in a field of view of the electrician 104, for example, to display virtual instructions regarding the power line maintenance.

Continuing with FIG. 1, the electrician 104 reaches for an exposed wire 122, and signals from one or more sensors residing on the wearable device 102 indicate that the exposed wire 122 is a live wire and that the electrician's hand is approaching the live wire. As the hand approaches the live wire 122, based upon the sensor signals, the wearable device 102 determines that the wearable device is likely to be in an unsafe state. To prevent the electrician from interacting with the live electrical wire 122, the motion-restricting system 108 receives, from logic residing on the wearable device and/or external to the wearable device (e.g., an on-board computer 116 of head-mounted display device 112), a control signal to activate the motion-restricting system 108. The motion-restricting system 108 applies a force in opposition to movement of one or more skeletal joints in the hand, and thereby impedes the electrician 104 from closing his hand around the live wire 122, thereby helping to protect the electrician 104.

Any suitable sensor data may be used to indicate whether the wearable device 102 (and thus the electrician's hand) is approaching the live wire 122. As one example, image data acquired by an integrated image sensor (e.g., a depth camera) of the head-mounted display device 112 may be input into a trained machine learning model (e.g. a neural network, decision tree, etc.) to determine a probability that the wearable device is in an unsafe state based upon the classification of objects in the image data. As a more specific example, depth image data can be used to identify the wearable device 102 and the exposed wire 122 and track relative positions between the identified objects. When the relative positions of the live wire 122 and the wearable device 102 approach one another, the trained machine learning model may output a determination that the wearable device 102 is likely in an unsafe state, and the head-mounted display device may provide an appropriate signal to the wearable device to actuate the motion-restricting system. As another example, a suitable electrical sensor (e.g. an electric field strength sensor) residing on the wearable device 102 may detect an increasing signal strength indicative of a decreasing distance between the wearable device 102 and a wire or other object with a high voltage differential.

In some examples, other sensor data may be used to augment image sensor data. For example, the wearable device 102 may include an inertial measurement unit (IMU) comprising one or more accelerometers, gyroscopes, and/or magnetometers. Motion information from such sensors may be used to determine a direction of motion, and thus may be used in combination with image data to determine whether the wearable device 102 is moving towards or away from the live wire 122. Motion information also may be determined from changes in image data over time. In either case, such motion data further may inform a decision whether to actuate the motion-restricting system of the wearable device 102.

In the example of FIG. 1, the determination to activate the motion-restricting system of the wearable device 102 is based upon an anticipated life-threatening situation, namely that the electrician 104 is in danger of grasping a live wire 122. In other situations, a user may approach a hazard in a manner that does not pose an imminent threat to a user. As such, the wearable device 102 may be configured to determine a different response to situations that pose a lesser threat compared to situations that pose a greater threat. As a more specific example, electricians sometimes briefly touch a backside of a hand to a wire of a suitably low voltage (e.g. 120V) to determine whether the wire is live. Such intentional interactions with a live wire of common household voltage may not pose risk of significant injury to the electrician. However, as an electrician also may perform such touches inadvertently rather than intentionally, and such touches may not be pleasant, it may be appropriate to output an alert of the risk that such a touch may be imminent. As such, a machine learning model used to detect potentially hazardous touches of live wires also may be trained to distinguish back-of-the-hand touch motions from grasping motions, and provide a different haptic output for the touches that pose a lower risk of harm. As a more specific example, a vibratory buzz may be output to alert the user of an imminent back-of-the-hand touch, whereas a motion restriction signal may be output in response to a possible grasping motion.

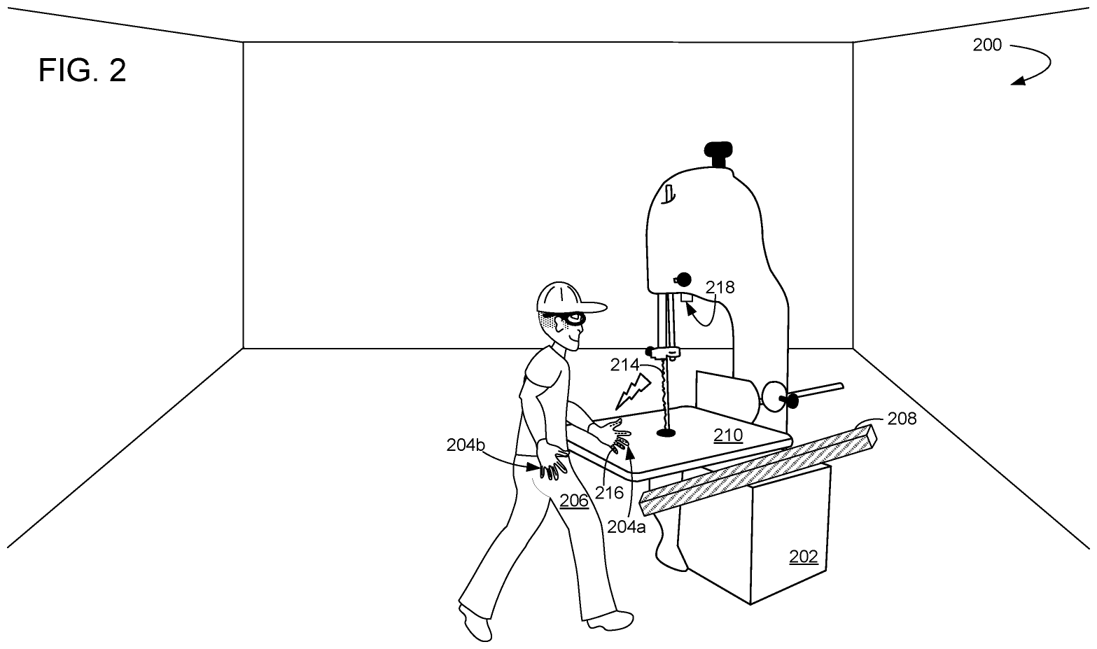

In the example above, sensors on the wearable device 102 and/or HMD 112 are used to sense the potentially hazardous situation. In other examples, a wearable device alternatively or additionally may receive sensor data from one or more external sensors positioned within a use environment of the wearable device. FIG. 2 depicts an example use scenario 200 in which a vertical band saw 202 communicatively coupled to wearable devices 204a and 204b via wireless connections sends sensor data to the wearable devices 204a and 204b via a suitable wireless communication protocol, such as Bluetooth or Wi-Fi. Attempting to grab a piece of lumber 208, the user reaches across a table 210 of the vertical band saw 202, and the wearable device 204a enters a range of an image sensing system 218 residing on the vertical bandsaw 202. In response to sensing a potentially hazardous situation via the image data from the image sensing system 218, the vertical band saw 202 sends sensor data to wearable device 204a indicating a proximity of the wearable device 204a to saw blade 214. In response to receiving this sensor data, the wearable device 204a sends a control signal to the motion-restricting system (one example of which is shown as 216) of the wearable device 204a to restrict movement of a joint(s) in the hand. Alternatively or additionally, the vertical band saw 202 may locally process the sensor data to identify the impending hazard and then send the control signal to the wearable device 204a.

Image sensing system 218 may comprise any suitable sensing hardware. For example, the image sensing system may comprise a depth image sensor and/or a two dimensional RGB image sensor directed downwards to capture images of the saw blade 214 and an area of the table 210 surrounding the saw blade. Further, the image data may be analyzed in any suitable manner. For example, object recognition may be used to locate a hand or other body part in the image data (e.g. using trained object classifiers, such as one or more neural networks, decision trees, etc.), a distance between the object and blade 214 may be determined, and a decision regarding whether to restriction motion may be made based upon the determined distance. Further, motion data (e.g. determined from image data or from IMU data on the wearable device) may be used to determine a motion vector, which may help inform the system whether the body part is moving closer to the blade. Where the position and/or direction of movement of the body part indicates that the person is at risk of injury, the wearable device 204a may be controlled to restrict motion or otherwise provide a haptic output informing the user 206 of the hazard. Processing to detect the hazardous situation may be performed by logic residing on the wearable device 204a, the vertical band saw 202, and/or another external computing device (e.g., a local computing device or cloud-based service).

In other examples, instead of sensing a physical manifestation of an unsafe state (e.g. temperature, electric field, noise, etc.) or a physical proximity to a potentially hazardous situation via image data, other sensing methods may be used. As one example, a use environment may be scanned using depth sensing technology to form a three-dimensional representation (e.g. a mesh representation or surface reconstruction) of the use environment. Then, potential hazards in the use environment may be mapped to the three-dimensional representation. The location of a wearable device then may be tracked within the use environment, and the motion-restricting system of the wearable device may be controlled to restrict possibly unsafe user movements when the wearable device is within a potentially unsafe proximity to the hazard. The location of the wearable device may be tracked in any suitable manner. For example, image sensors worn on a user (e.g. depth image sensors and/or RGB image sensors built into a HMD worn by the user) may track the location of the wearable device. Inertial motion sensors on the wearable device may augment the image data and help to track motion when the wearable device is out of a field of view of the image sensor(s), and/or when a view of the wearable device is occluded by other objects. Stationary image sensors in the use environment may be similarly used.

In some examples, state information regarding a current state of a machine or other object also may be used when determining whether a hazardous condition exists. For example, a use state of the vertical bandsaw 202 may be used when determining whether to control a motion-restricting system of the wearable device 204a. As a more specific example, when the band saw is in an “on” power state but the blade is not moving, this information may be used by the wearable device 204a, the bandsaw 202, and/or other computing device to determine not to restrict user motion as a body part approaches the stationary blade, or to output a different response (e.g. a vibratory buzz) than when the blade is moving. Other hazard conditions posed by other machines may similarly use state information to help to determine whether a hazardous condition exists. Other examples include a power state of a machine, a rotational speed of a moving part, a flow speed, a nozzle pressure, a temperature setting, etc.

In instances in which a machine is not in communication with a wearable device and/or the machine does not provide information regarding its state, a wearable device may be able to ascertain a state of the machine from other sensor data. For example, the wearable device may determine a machine state via sounds detected via an acoustic sensor, or may observe a power draw on an electrical system to which the machinery is connected (e.g. via appropriate power meters configured to sense power usage by the machinery). In other examples, a wearable device or other computing system providing control signals to a wearable device may sense a current state of a potentially hazardous machine in any other suitable manner.

In some examples, a wearable device may implement additional safety features than motion restriction. For example, a wearable device may include a user authentication system (e.g. based upon user ID/password, biometric factors, etc.) configured to identify a particular user and associate the user as currently wearing the wearable device. When authenticated to the wearable device, identification information for the user may be used to determine whether the user is authorized and/or trained to use various equipment (e.g., machinery, tools, access-restricted areas, etc.) in a use environment. The wearable device may activate a motion-restricting system to prevent a user from operating equipment which the user is not trained and/or authorized to use, to prevent a user from accessing an unauthorized area, and/or for any other suitable purpose, which may help reduce a likelihood of injury.

A wearable device further may notify a user regarding a hazardous situation in a noisy, chaotic or otherwise distracting environment in which a warning signal output by another device may be missed. As one example, a worker working in a confined space (on an oil rig, in a municipal sewer, etc.) may wear an air quality monitor and gloves as part of a uniform. Commercially-available air quality monitors worn in such environments may be enclosed in a durable, metal receptacle configured to be worn on a worker's waist, and may include one or more output devices to emit a light, a sound, or a vibration in response to detecting an air quality danger. However, such work environments may have a low signal-to-noise ratio, which may be exacerbated in the presence of a hazardous situation and thereby hinder user detection of the light, sound, or vibration output by the air sensor. Thus, the worker may wear a wearable device in the form of electronic gloves, or another suitable wearable device. The wearable device may communicate with the air quality sensor to provide additional feedback (such as a vibration, mechanical force to resist movement of a skeletal joint, etc.). In this manner, the wearable device may alert the worker to an impending hazard in a manner that the worker is more likely to notice in a noisy environment.

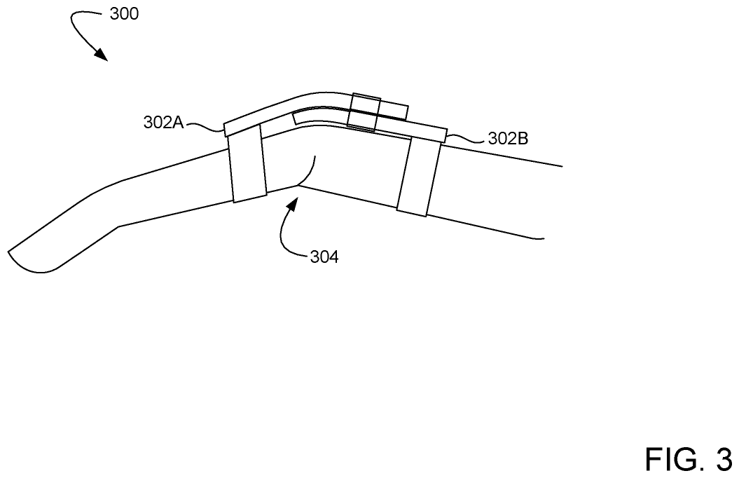

A wearable device may comprise any suitable motion-restricting system configured to restrict movement of a skeletal joint(s). FIG. 3 schematically shows an example motion-restricting system 300 in the form of an electrostatic slide clutch. The electrostatic slide clutch is configured to vary the sliding and/or static frictional force between two substrates 302 movable translationally with respect to each other. In the example of FIG. 3, a first substrate 302A is coupled to the skin on a first side of a skeletal joint 304, and a second substrate 302B is coupled on a second, opposite side of the skeletal joint. A first electrode is formed on or bonded to a first substrate 302A and a second electrode is formed on or bonded to a second substrate 302B. One or both of the first and second electrodes may be formed on or bonded to a substrate, and one or both of the substrates may be secured to the skin. In other examples, an electrode may be applied directly to the skin, such that no distinct substrate is required for that electrode. At least one electrically insulating structure is disposed between the first electrode and the second electrode, for example, on a face of the first electrode facing the second electrode and/or on a face of the second electrode facing the first electrode.

Electrostatic slide clutch 300 further includes a controller (not shown) electrically coupled to the first electrode and to the second electrode and configured to apply a variable voltage between the first and second electrodes, to influence a normal force between the first and second electrodes. Positive voltage may be applied to the first electrode relative to the second electrode, or vice versa. In some examples, an alternating voltage of suitable frequency may be used, to facilitate dynamically changing the force applied during sliding operation. Applying voltage of either polarity causes an amount of unbalanced charge to form on the opposing surfaces of the electrodes, which draws the electrodes together via the Coulomb force. Increasing normal force brings about a corresponding increase in both static and sliding friction forces between the electrically insulating structure and the opposing electrode.

The motion-restricting system 300 depicted in FIG. 3 may alternatively or additionally comprise a magnetic actuator configured to vary a force of interaction between two magnetic layers 302 movable translationally with respect to each other. More specifically, a first magnetic layer 302A is coupled to the skin on a first side of a skeletal joint 304, and a second magnetic layer 302B is coupled in sliding relation with first magnetic layer 302A. Each of the first and second magnetic layers may be secured to the skin of the user, or otherwise closely coupled to an articulable region of the body. Each of the first and second magnetic layers is configured to support a plurality of magnetic dipoles—e.g., magnetic dipoles of the first magnetic layer and magnetic dipoles of the second magnetic layer. The magnetic actuator also includes a control circuit (not shown) configured to controllably form or reorient the magnetic dipoles of at least the first magnetic layer, and thereby modify a force of interaction between the first and second magnetic layers. In the illustrated example, the first magnetic layer 302A and the second magnetic layer 302B are held in close contact via a guide 306, which permits the layers to slide relative to one another. In other examples, any other suitable structure for holding the layers in sufficiently close contact may be used, or the magnetic layers may be self-supporting.

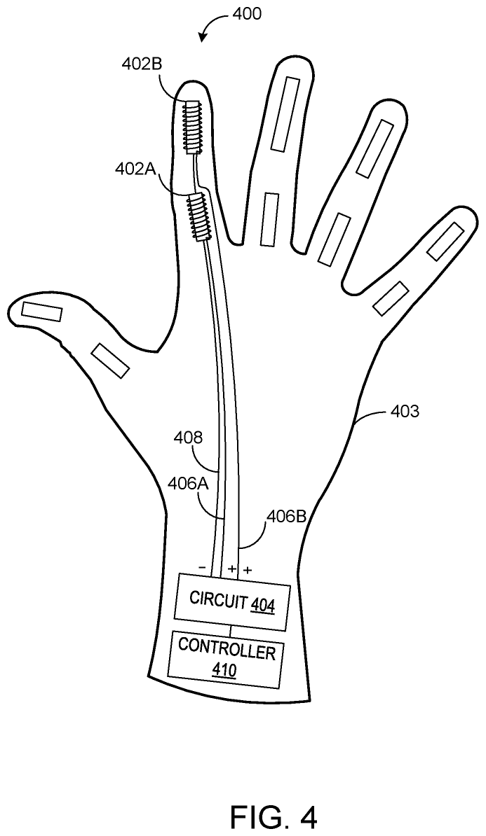

Configurations differing from that of FIG. 3 are also envisaged. In one example, the motion-restricting system may take the form of a tube around the finger that becomes stiffer to restrict movement. As another example, FIG. 4 depicts an example motion-restricting system 400 in the form of a fluid having an adjustable viscosity configured to provide mechanical resistance to movement of a skeletal joint(s). Motion-restricting system 400 includes a plurality of fluidic channels such as fluidic channels 402A and 402B, in which an electrorheological fluid is disposed. The electrorheological fluid has an electrically adjustable viscosity that can be adjusted by varying an electric field applied to the fluid. By adjusting the fluid viscosity in fluidic channels 402A and 402B, which are shown as being arranged at an index finger portion of the motion-restricting system 400, a variable mechanical resistance to motion of an index finger may be provided. Similarly, fluidic channel(s) may be arranged at alternative or additional locations of a wearable device (shown as electronic glove 403) to provide variable mechanical resistance at such locations. As an example, FIG. 4 shows fluidic channels arranged at each digit portion to provide variable mechanical resistance for each digit of a user's hand. Any suitable arrangement and number of fluidic channels for any joints of the hand may be used. For example, instead of using separate channels at each knuckle of a digit, a channel may extend across multiple knuckles of a digit.

FIG. 4 also shows a block diagram of example circuitry 404 for varying an electric field applied to the fluid channels 402A, 402B via signal lines (+) 406A, 406B respectively for channels 402A and 402B and a common ground line (−) 408. Signal lines 406 comprise a conductive wire or other suitable conductor wound around fluidic channels 402, and ground line 408 comprises a conductor extending along each fluidic channel in a location relative to each signal line to create a desired electric field within each fluidic channel when the signal line is energized. By creating a voltage difference between signal lines 406A,B and ground line 408, electric field may be established between the signal and ground lines to vary the electrorheological fluid viscosity in the fluidic channels as described above. Signals may be applied separately to signal lines 406A and 406B to allow individual control of haptic feedback applied to different portions of a user's finger. In the depicted example, each fluidic channel is controlled by separate signal lines, while in other examples a same signal line may be used to control two or more channels. While shown only for fluidic channels 402A,B in FIG. 4 for clarity, it will be understood that other fluidic channels also include similar control circuitry. Also, in other examples, the signal lines may be printed onto a surface of the channels, or printed onto fabric or other substrate adjacent to the channels. A controller 410 may control circuitry 404, to control the application of electric fields within fluidic channels 402 to adjust the viscosity of the electrorheological fluid in fluidic channels 402 and simulate a resistive sensation against movement of a joint. It will be understood that the example illustrated in FIG. 4 may utilize a magnetorheological fluid as an alternative to electrorheological fluid, and the controller may be configured to control the circuitry to control the induction of magnetic fields to adjust a viscosity of the magnetorheological fluid, without departing from the scope of this disclosure.

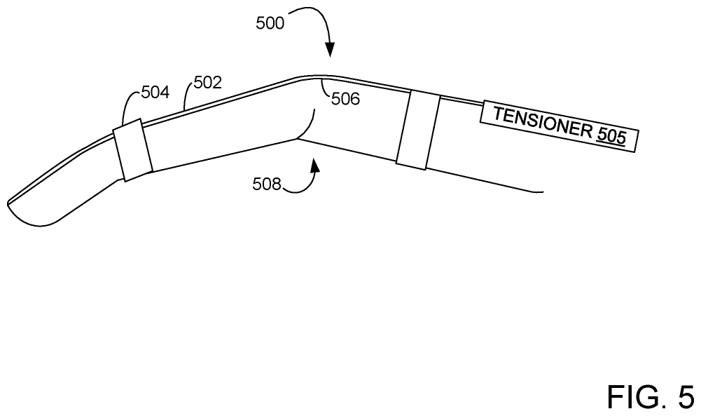

As another example, a motion-restricting system may be configured to use mechanical force to restrict movement of a skeletal joint(s). FIG. 5 depicts an example motion-restricting system 500 comprising a cable 502 and a mechanical mechanism 504 configured to cease motion of the cable when the motion-restricting system 500 is activated. As one example, the mechanical mechanism may comprise a clamp including opposing frictional (e.g. toothed) surfaces through which the cable freely travels when the motion-restricting system 500 is deactivated, and which compress opposing surfaces of the cable to restrict motion of the cable therethrough when the motion-restricting system 500 is activated. Motion-restricting system 500 further comprises a tensioner 505 (e.g. an elastomer segment or a mechanical spool controlled by a motor) to maintain tension in the cable as a finger extends. In another example, a spool controlled by a motor may itself provide resistive mechanical force, instead of or in addition to clamps. When the motion-restricting system 500 is activated, the motor controlling the spool may be controlled to resist unwinding of the cable 502 and/or to actively retract the cable 502. In the illustrated example, the cable 502 traverses a path along a first side 508 of a user's skeletal joint 506, such that when activated, the motion-restricting system 500 exerts a resistive force against flexion of the skeletal joint 508. In other examples, a mechanical motion-restricting system may comprise any other suitable configuration.

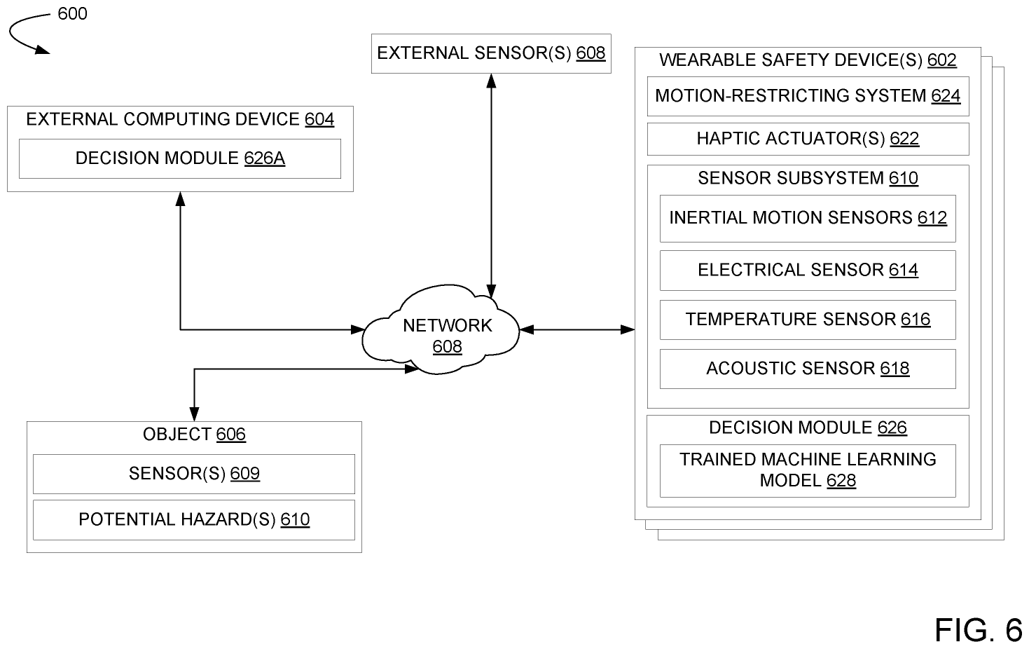

FIG. 6 shows a block diagram of a system 600 comprising one or more wearable devices 602 configured to restrict user motion in response to a potentially hazardous condition posed by an object 606 (e.g. a machine, an electrical conductor, a heat source, etc.) in the environment. Wearable device(s) 602 may represent one or more wearable devices worn by a single user (e.g., a sleeve and a glove, two gloves, etc.), as well as wearable devices worn by different users within a use environment. Each wearable device 602 may take the form of an electronic glove, a sleeve configured to be worn on an appendage, or any other suitable wearable garment configured to be worn on a skeletal joint.

Each wearable device includes a motion-restriction system 624 configured to restriction skeletal motion when actuated. Any suitable mechanism may be used to restrict motion, including the above-described electrostatic, magnetic, fluidic and mechanical methods.

System 600 further comprises one or more sensors configured to sense conditions that may be indicative of hazardous situations. In some examples, each wearable device 602 comprises a sensor subsystem 610 having one or more sensors. A sensor subsystem 610 on a wearable device may include sensors configured to directly sense manifestations of possibly hazardous conditions, such as nearby high voltage differentials, operating machinery, and extreme temperatures. Examples of such sensors include electrical sensors (e.g. an electric field sensor, current sensor, voltage sensor, etc.), acoustic sensors (e.g. to detect noises that indicate machine operating conditions), and temperatures sensors (e.g. suitable thermocouple junctions, infrared temperature sensors, etc.).

A sensor subsystem on a wearable device also may include sensors that may not directly sense potentially hazardous conditions, but that can provide information to augment other sensor data to help decide whether a hazardous situation may exist. For example, the sensor subsystem may include inertial motion sensors 612 (e.g., one or more accelerometers, magnetometers, and/or gyroscopes) that can be used to provide motion data to augment image data received from image sensors. As described above, wearable device(s) 602 may be configured to receive image data from external image sensors, which may reside on object 606 to monitor potential hazard(s) 610, or from sensors 608 that reside elsewhere in the use environment. Such image data may be analyzed to decide whether a hazardous condition exists. However, whether such a condition exists may depend upon whether a user is moving a body part toward or away from the potential hazard 610. As such, inertial motion data may be used along with image data to make this decision. As a more specific example, a distance between a wearable device and a potential hazard at which a hazardous situation is determined to exist may be shorter when the wearable device is moving toward the potential hazard than when the wearable device is moving away from the potential hazard.

System 600 further may comprise other external sensors than image sensors. For example, where a potential hazard poses a thermal hazard, external sensors 608 and/or 609 may comprise a temperature sensor for sensing surface temperature within a given measuring range. As another example, external sensors 608 and/or sensors 609 may comprise a vibration sensor (such as an accelerometer) and/or an acoustic sensor to measure vibration and/or sound signals arising from object 606. It will be understood that, in various examples, hazardous situations may be sensed via sensors only on the wearable device, sensors only external to the wearable device, or combinations of sensors on and external to the wearable device.

System 600 may use any suitable methods to analyze sensor data to detect potentially hazardous situations, and to provide control signals to the motion-restricting system 624. In some examples, each wearable device 602 may comprise a decision module 626 that receives sensor data (raw or processed) as input, and outputs a determination regarding whether the wearable device is likely to be in an unsafe state. In other examples, some or all aspects of the decision module 626 may be implemented on an external computing device 606, and/or distributed across multiple devices, as indicated by decision module 626A within an external computing device 604 and decision module 626 within wearable device 602. External computing device 604 may represent any suitable computing device, whether local to the use environment (e.g. a head-mounted device or other wearable device, a laptop, tablet, desktop computer, etc.) or remote (e.g. implemented as a cloud-based service). Further, in some examples, system 600 may comprise multiple external computing devices 606.

The decision module 626 may use a heuristic approach in which a current state of the wearable device(s) 602 is classified as safe or unsafe based upon predetermined rules. As an example, the decision module 626 may compare a signal received from one or more sensors to a threshold (e.g. comparing a sensed temperature to a threshold temperature), and determine whether the wearable device is likely to be in an unsafe state based upon the comparison. As another example, where potential hazard 610 is mapped to a three-dimensional location within a mesh or surface reconstruction model of a use environment, position data indicating that a wearable device is within a threshold distance of the potential hazard 610 may be used to actuate the motion-restricting system.

The decision module 626 alternatively or additionally may utilize machine learning techniques to identify potentially hazardous situations. Machine learning techniques may be used where heuristic methods are not practical and/or where a richer sensor data set can be obtained, such as where multiple sensors are providing data regarding a current state of the wearable device(s) 602 and/or conditions of a use environment. The use of machine learning techniques may also be employed where the decision module 626 receives competing signals from sensors, and/or the signal(s) received may not directly correlate to a known response.

As depicted, the decision module 626 comprises a trained machine learning model 628 including one or more trained machine learning functions to infer whether the wearable device(s) 602 is likely to be in an unsafe state. In such an example, a feature vector comprising currently observed sensor data (e.g., electric field strength, temperature, acceleration, position, orientation, etc.) and environmental signal features (e.g., temperature, location of hazardous areas, electric current, voltage, motion, sound, machine state, etc.) may be input into the trained machine learning model to obtain an output of a determination of a probability that the wearable device is in an unsafe state. As different hazards are present in different industries and businesses, as well as different use environments of the same industry and/or business, a localized training approach may be used, wherein training data representative of various interactions, both safe and unsafe, with an object of interest (e.g. a particular machine, a power line, etc.) are captured, labeled, and input into the model as ground truth. Once trained, the trained machine learning model 628 may be further refined for a particular user of a wearable device based upon ongoing training with the user. This may comprise receiving explicit user feedback regarding whether a response to a current state (e.g., activating a motion-restricting system) was a correct response, and inputting the feedback as training data for the trained machine learning model 628. Additionally or alternatively, implicit user feedback may be obtained and used as training data, for example, based upon observing that a user deactivated the motion-restricting system.

A trained machine learning model also may be used to identify problems with machinery or other equipment that may not be readily observable but that may pose a danger to a user. For example, the trained machine learning model 628 may be used to infer a sequence or pattern within sensor data obtained that indicates a potential current or future hazard (e.g., data indicating a resonance condition), and to output a determination that an unsafe condition may exist. The wearable safety device receiving this determination then may output a warning to the user. As another example, the decision module 626 may help identify a weak portion of a structure that is visually undetectable but can be sensed based upon a learned signal, such as an internal fracture in a metal object (e.g. a machine) that is sensed based upon inputting a sensed vibration signal from the metal object into the trained machine learning model 628.

Any suitable methods may be used to train such a machine learning model. As mentioned above, a supervised training approach may be used in which environmental signal features having a known outcome (e.g., safe or unsafe) based upon known wearable device signal features have been labeled with the outcome and used for training. Supervised machine learning may use any suitable classifier, including decision trees, random forests, support vector machines, and/or neural networks.

Unsupervised machine learning also may be used, in which wearable device signals may be received as unlabeled data, and patterns are learned over time. Suitable unsupervised machine learning algorithms may include K-means clustering models, Gaussian models, and principal component analysis models, among others. Such approaches may produce, for example, a cluster, a manifold, or a graph that may be used to make predictions related to situations which may be safe or unsafe based upon features in current wearable device and use environment signals.

In some examples, the decision module may output different control signals to the motion-restricting system for different identified hazardous situations. For example, where the decision module determines that a user is likely to grasp a live wire, the output may comprise a motion restriction signal. In contrast, where it is determined that the user is likely to touch the back of a hand to a lower voltage wire, a vibrational alert may be output.

The wearable device(s) 602 also may comprise other output devices than the motion-restricting system 624. For example, each wearable device may include one or more haptic actuators 622 configured to provide haptic feedback (e.g., a vibration). Other examples include one or more light sources and/or one or more speakers.

Wearable device(s) 602 may include other components not shown in FIG. 6. For example, the wearable device(s) 602 comprises a power supply, such as one or more batteries, which may be rechargeable between uses and/or replaceable. The wearable device(s) 602 also may comprise an override control for deactivating the motion-restricting system 624. Such an override control may take any suitable form, such as a mechanical input device (e.g., a button), a touch sensor, and/or a microphone for verbally inputting an override command phrase. Where an override control is provided, instances in which a user overrides activation of the motion-restricting system 624 may be used as further training data to train a machine learning model. In some examples, override signals may be input via a different device in communication with the wearable device, such as the external computing device 604.

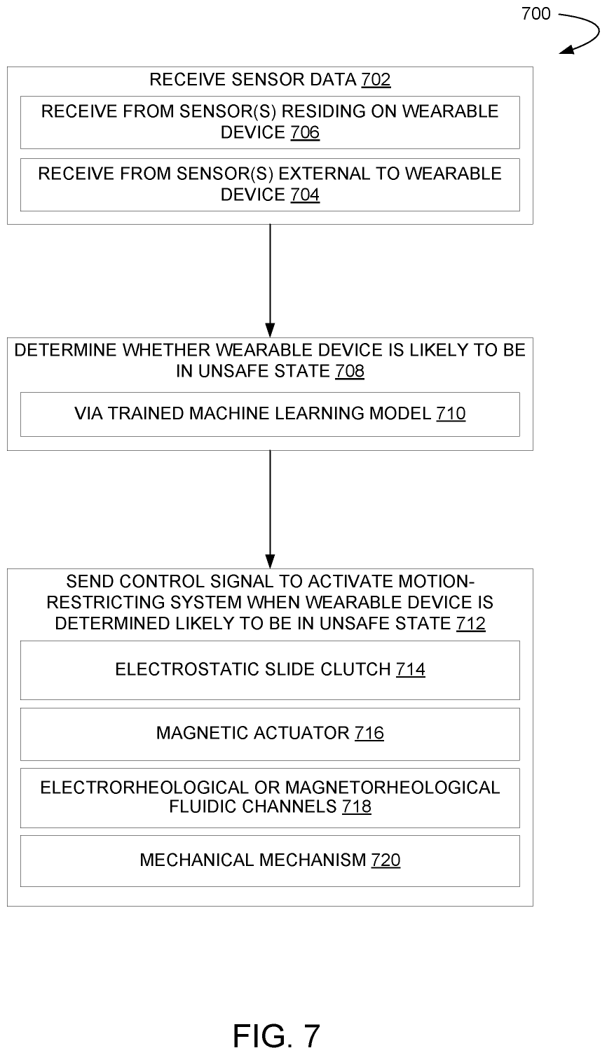

As mentioned above, decision making regarding whether a wearable device is likely to be in an unsafe state may be determined at the intelligent edge via logic residing on the wearable device. FIG. 7 shows a flowchart illustrating an example method 700 for controlling a motion-restricting system via a wearable device. Method 700 may be implemented as stored instructions executable by a logic subsystem (e.g., decision module 624) of a wearable device, such as wearable devices 102, 204a, 204b, 403, and/or 602.

At 702, method 700 comprises receiving sensor data from one or more sensors. Any suitable sensor data may be received, including image data, IMU data, an electric field strength signal or other electrical sensor signal, a temperature signal, a motion signal, and/or an audio signal. Such sensor data may be received from one or more sensors residing on the wearable safety device, as indicated at 706. Additionally or alternatively, such sensor data may be received from one or more sensors external to the wearable device, as indicated at 708. For example, external sensor data may comprise image data (depth and/or two dimensional), temperature data, machine state data (e.g., a power status of tools, machinery, etc.), and/or location data (e.g. a location of a wearable device as determined from sensors in the use environment, etc. In any instance, the sensor data may be provided in the form of raw sensor data or processed sensor data.

Based at least upon the sensor data received, method 700 comprises, at 704, determining whether the wearable device is likely to be in an unsafe state. For example, logic residing on a wearable device may determine whether the wearable safety is likely to be in an unsafe state based upon heuristics. In a heuristic approach, the wearable device may classify a current state as “safe” or “unsafe” based upon comparing sensor data received to predetermined rules. For example, the wearable device may compare sensor data received from a temperature sensor to a threshold and determine whether the current state is “safe” or “unsafe” based upon the sensor data being less than or not less than the threshold, respectively. As another example, the wearable device may compare image sensor data received from an image sensor that indicates a distance between a body part or wearable device and a potential hazard, and compare the distance to a threshold to determine whether the current state is “safe” or “unsafe”. Alternatively or additionally, in some examples, determining whether the wearable device is likely to be in an unsafe state comprises, at 710, determining via a trained machine learning model a probability that the wearable device is in an unsafe state.

When the wearable device is determined likely to be in the unsafe state, method 700 comprises, at 712, sending a control signal to activate a motion-restricting system of the wearable device. In examples where the motion-restricting system comprises an electrostatic slide clutch 714, sending the control signal may comprise sending a signal to vary a voltage between two electrodes of the electrostatic slide clutch to influence a normal force between the electrodes. In examples where the motion-restricting system comprises a magnetic actuator 716, sending the control signal may comprise inducing a magnetic field (e.g., via passage of an electric current) to controllably form or reorient the magnetic dipoles of at least the first magnetic layer, and thereby modify a force of interaction between the first and second magnetic layers. In examples where the motion-restricting system comprises an electrorheological (or magnetorheological) fluidic channel 718, sending the control signal may comprise controlling the application of electric (or magnetic) fields within fluidic channels to adjust the viscosity of the electrorheological (or magnetorheological) fluid in the fluidic channels. In examples where the motion-restricting system comprises a mechanical mechanism 720, sending the control signal may comprise sending a signal to actuate or otherwise activate the mechanical mechanism such that movement of a skeletal joint is restricted.

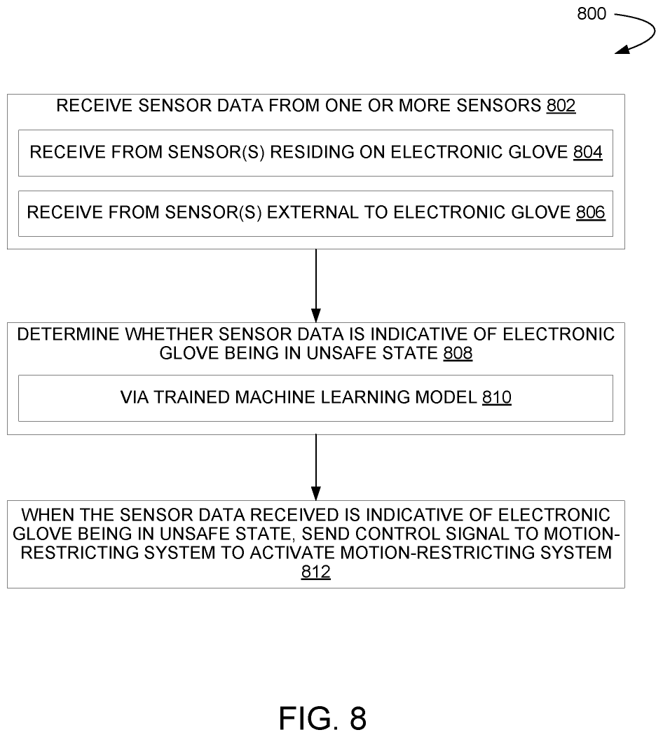

In some examples, logic hardware may additionally or alternatively reside external to a wearable device. FIG. 8 shows a flowchart illustrating an example method 800 for controlling a motion-restricting system of an electronic glove (or other wearable device) via an external computing device. Method 800 may be implemented as stored instructions executable by a logic subsystem of a computing device in communication with the wearable device.

At 802, method 800 comprises receiving sensor data from one or more sensors. Any suitable sensor data may be received, including image data, IMU data, an electric field strength signal or other electrical sensor signal, a temperature signal, a motion signal, and/or an audio signal. Sensor data may be received from one or more sensors residing on the electronic glove 804 and/or from one or more sensors external to the electronic glove 806. In any instance, the sensor data may be provided in the form of raw sensor data or processed sensor data.

Based on the sensor data received, method 800 may comprise, at 808, determining whether the sensor data is indicative of the electronic glove being in an unsafe state. In some examples, determining whether the sensor data is indicative of the electronic glove being in an unsafe state comprises determining via a heuristics approach. In other examples, determining whether the sensor data is indicative of the electronic glove being in an unsafe state comprises obtaining a determination from a trained machine learning model, as indicated at 810.

When the sensor data received in indicative of the electronic glove being in the unsafe state, method 800 comprises, at 812, sending a control signal to a motion-restricting system of the electronic glove to activate the motion-restricting system. Any suitable control signal may be sent to the motion-restricting system, including the examples described herein with reference to FIGS. 3, 4, 5, and 7. Further, the control signal may be sent via any suitable communication protocol, including Bluetooth and Wi-Fi.

In some embodiments, the methods and processes described herein may be tied to a computing system of one or more computing devices. In particular, such methods and processes may be implemented as a computer-application program or service, an application-programming interface (API), a library, and/or other computer-program product.

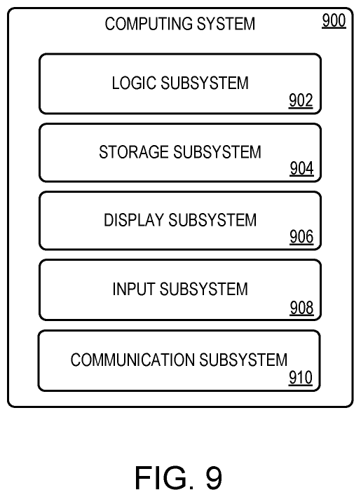

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module” and “program” may be used to describe an aspect of computing system 900 implemented to perform a particular function. In some cases, a module or program may be instantiated via logic machine 902 executing instructions held by storage machine 904. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module” and “program” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

Another example provides a wearable device comprising a motion-restricting system configured to restrict movement of a skeletal joint when activated, a logic subsystem, and memory storing instructions executable by the logic subsystem to receive sensor data from one or more sensors, based at least on the sensor data received, determine whether the wearable device is likely to be in an unsafe state, and when the wearable device is determined likely to be in the unsafe state, send a control signal to the motion-restricting system to activate the motion-restricting system. In such an example, the instructions may additionally or alternatively be executable to receive the sensor data from one or more sensors external to the wearable device. In such an example, the instructions may additionally or alternatively be executable to receive the sensor data from one or more sensors residing on the wearable device. In such an example, the instructions may additionally or alternatively be executable to determine whether the wearable device is likely to be in the unsafe state based upon one or more of a temperature signal, an electric current signal, an audio signal, and/or a motion signal. In such an example, the instructions may additionally or alternatively be executable to determine whether the wearable device is likely to be in the unsafe state via a trained machine learning model. In such an example, the wearable device may additionally or alternatively comprise a glove. In such an example, the motion-restricting system may additionally or alternatively comprise an electrostatic slide clutch. In such an example, the motion-restricting system may additionally or alternatively comprise a magnetic actuator. In such an example, the motion-restricting system may additionally or alternatively comprise a fluidic channel having fluid disposed therein, the fluid including an adjustable viscosity, and a circuit configured to vary a field within the fluidic channel. In such an example, the motion-restricting system may additionally or alternatively comprise a cable and a mechanical mechanism, the mechanical mechanism configured to cease motion of the cable when the motion-restricting system is activated.

Another example provides an electronic glove configured to be worn on a hand of a user, the electronic glove comprising a motion-restricting system configured to restrict motion of one or more skeletal joints of the hand when activated, a logic subsystem, and memory storing instructions executable by the logic subsystem to receive sensor data from one or more sensors, and when the sensor data received is indicative of the electronic glove being in an unsafe state, send a control signal to the motion-restricting system to activate the motion-restricting system. In such an example, the instructions may additionally or alternatively be executable to receive the sensor data from one or more sensors residing on the electronic glove. In such an example, the sensor data received may additionally or alternatively comprise one or more of a temperature signal, a motion signal, an electric current signal, and/or an audio signal. In such an example, the instructions may additionally or alternatively be executable to receive the sensor data from one or more sensors external to the glove. In such an example, the sensor data received may additionally or alternatively comprise a power status of one or more electronic devices within an environment of the electronic glove, and a proximity of the electronic glove to the one or more electronic devices. In such an example, the instructions may additionally or alternatively be executable to obtain, from a trained machine learning model, a determination that the sensor data received is indicative of the electronic glove being in the unsafe state.

Another example provides, on a computing device, a method comprising receiving sensor data regarding a current state of a wearable device, inputting the sensor data received into a trained machine learning model, obtaining, from the trained machine learning model, a determination as to whether the wearable device is likely to be in an unsafe state, and when it is determined that the wearable device is likely in the unsafe state, then control a motion restricting system of the wearable device. In such an example, receiving the sensor data may additionally or alternatively comprise receiving the sensor data from one or more sensors residing on the wearable device. In such an example, controlling the motion-restricting system of the wearable device may additionally or alternatively comprise sending a control signal to the motion-restricting system to activate the motion-restricting system. In such an example, receiving the sensor data regarding the current state of the wearable device may additionally or alternatively comprise receiving the sensor data from one or more sensors external to the wearable device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A wearable device comprising:
a motion-restricting system configured to restrict movement of a skeletal joint when activated;
a logic subsystem; and
memory storing instructions executable by the logic subsystem to receive sensor data from one or more sensors;
based at least on the sensor data received, determine whether the wearable device is likely to be in an unsafe state; and
when the wearable device is determined likely to be in the unsafe state, send a control signal to the motion-restricting system to activate the motion-restricting system.

2. The wearable device of claim 1, wherein the instructions are executable to receive the sensor data from one or more sensors external to the wearable device.

3. The wearable device of claim 1, wherein the instructions are executable to receive the sensor data from one or more sensors residing on the wearable device.

4. The wearable device of claim 1, wherein the instructions are executable to determine whether the wearable device is likely to be in the unsafe state based upon one or more of a temperature signal, an electric current signal, an audio signal, and/or a motion signal.

5. The wearable device of claim 1, wherein the instructions are executable to determine whether the wearable device is likely to be in the unsafe state via a trained machine learning model.

6. The wearable device of claim 1, wherein the wearable device comprises a glove.

7. The wearable device of claim 1, wherein the motion-restricting system comprises an electrostatic slide clutch.

8. The wearable device of claim 1, wherein the motion-restricting system comprises a magnetic actuator.

9. The wearable device of claim 1, wherein the motion-restricting system comprises a fluidic channel having fluid disposed therein, the fluid including an adjustable viscosity, and a circuit configured to vary a field within the fluidic channel.

10. The wearable device of claim 1, wherein the motion-restricting system comprises a cable and a mechanical mechanism, the mechanical mechanism configured to cease motion of the cable when the motion-restricting system is activated.

11. An electronic glove configured to be worn on a hand of a user, the electronic glove comprising:
a motion-restricting system configured to restrict motion of one or more skeletal joints of the hand when activated;
a logic subsystem; and
memory storing instructions executable by the logic subsystem to receive sensor data from one or more sensors; and
when the sensor data received is indicative of the electronic glove being in an unsafe state, send a control signal to the motion-restricting system to activate the motion-restricting system.

12. The electronic glove of claim 11, wherein the instructions are executable to receive the sensor data from one or more sensors residing on the electronic glove.

13. The electronic glove of claim 11, wherein the sensor data received comprises one or more of a temperature signal, a motion signal, an electric current signal, and/or an audio signal.

14. The electronic glove of claim 11, wherein the instructions are executable to receive the sensor data from one or more sensors external to the glove.

15. The electronic glove of claim 14, wherein the sensor data received comprises a power status of one or more electronic devices within an environment of the electronic glove, and a proximity of the electronic glove to the one or more electronic devices.

16. The electronic glove of claim 11, wherein the instructions are further executable to obtain, from a trained machine learning model, a determination that the sensor data received is indicative of the electronic glove being in the unsafe state.

17. On a computing device, a method comprising:
receiving sensor data regarding a current state of a wearable device;
inputting the sensor data received into a trained machine learning model;
obtaining, from the trained machine learning model, a determination as to whether the wearable device is likely to be in an unsafe state; and
when it is determined that the wearable device is likely in the unsafe state, then control a motion restricting system of the wearable device.

18. The method of claim 17, wherein receiving the sensor data comprises receiving the sensor data from one or more sensors residing on the wearable device.

19. The method of claim 17, wherein controlling the motion-restricting system of the wearable device comprises sending a control signal to the motion-restricting system to activate the motion-restricting system.

20. The method of claim 17, wherein receiving the sensor data regarding the current state of the wearable device comprises receiving the sensor data from one or more sensors external to the wearable device.
